(19) United States
(12) Patent Application Publication
(10) Pub. No.: US 2005/0078582 A1
(43) Pub. Date: Apr. 14, 2005

(54) Optical recording/reproducing apparatus capable of canceling data recording process and data recording cancel method thereof

(75) Inventor: Sang-cheol Choi, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/936,812

(22) Filed: Sep. 9, 2004

(30) Foreign Application Priority Data
Sep. 9, 2003 (KR) 2003-0063385

(51) Int. Cl. G11B 5/09

(52) U.S. Cl. 369/53.31; 369/47.32

(57) ABSTRACT

An optical recording/reproducing apparatus that provides a feature for canceling data recording processes and a data recording cancel method thereof. The optical recording/reproducing apparatus includes a controller for generating and storing management information in a temporary management file and when receiving a recording cancel request signal while in the process of recording a data stream, the controller stops the operation and initializes the temporary management file. In doing so, the optical recording/reproducing apparatus cancels the data recording process with only one key manipulation by initializing a navigation file of the recording data.

### CROSS-REFERENCE TO RELATED APPLICATIONS

This application claims the benefit under 35 U.S.C. §119(a) of Korean Patent Application No. 2003-63385 entitled “Optical Recording/Reproducing Apparatus Capable Of Canceling Data Recording Process And Data Recording Cancel Method Thereof”, filed in the Korean Intellectual Property Office on Sep. 9, 2003, the entire contents of which are incorporated herein by reference.

### BACKGROUND OF THE INVENTION

1. Field of the Invention

The present invention relates to an optical recording/reproducing apparatus capable of canceling data recording processes and a data recording cancel method thereof. More particularly, the present invention relates to an optical recording/reproducing apparatus capable of canceling data recording processes with one simple key manipulation, and a data recording cancel method for the use thereof.

2. Description of the Related Art

A large number of devices currently exist for recording and reproducing data using an optical recording medium. To simplify the discussion below, one such device, a DVDR (Digital Versatile Disc Recorder) is presented as an example of one currently available optical recording/reproducing apparatus which can record and reproduce data to and from an optical recording medium. The DVDR records and/or reproduces data to and from an optical recording medium, such as a DVD (Digital Versatile Disc) and a CD (Compact Disk).

Such an optical recording/reproducing apparatus records motion pictures after compression such as provided by the MPEG-2 technology, under the direction of a file system format, such as UDF (Universal Disk Format). The UDF is a file system format for the optical medium and is used to record and/or reproduce an MPEG motion picture file to and from a DVD.

During the process of recording an externally provided motion picture file on a DVD, a user may want to delete the file being recorded on the DVD before the recording process of the file is completed. In this case, the optical recording/reproducing apparatus temporarily stops the recording process and deletes the file being currently recorded. However, in order to delete the recording file, the conventional optical recording/reproducing apparatus has to perform the following complicated processes.

When receiving a recording cancel command from an external input device such as a remote controller during the recording process, the optical recording/reproducing apparatus stops the recording process of the motion picture file and displays a menu list as shown in FIG. 1 on a screen. The example menu list 100 shown in FIG. 1 displays the names of the files that have been recorded, and the name of the file being currently recorded.

When the menu list 100 is displayed on the screen as shown in FIG. 1, a user searches and selects the currently-recording motion picture file using the external input device, and inputs a delete command with respect to the selected file, which is illustrated in the shaded bar of FIG. 1. When receiving the delete command from the external input device, the optical recording/reproducing apparatus then deletes the currently-recording file.

As described above, to delete the currently-recording file, the conventional optical recording/reproducing apparatus has to display the menu list 100 including the files to be deleted, and thereafter requires the user to manually select the file to be deleted from the menu list 100. Therefore, several manipulations of the external input device and considerable time is required to delete the currently-recording file.

Accordingly, a need exists for a system and method to cancel a data recording process without requiring menu list displays or extensive key manipulations.

### SUMMARY OF THE INVENTION

Embodiments of the present invention have been developed in order to solve the problems described above. Accordingly, it is an object of the present invention to provide an optical recording/reproducing apparatus capable of canceling a data recording process with one simple key manipulation, and a data recording cancel method for use thereof.

The above and other objects are achieved by providing an optical recording/reproducing apparatus which is capable of canceling data recording processes, and also capable of recording a motion picture file provided from an image source on an optical recording medium. In recording the motion picture file, the optical recording/reproducing apparatus records an actual data stream on a data stream file of the optical recording medium while temporarily storing management information of the actual data stream in a temporary management file of a buffer.

When a recording cancel request mode is selected during the recording, the encoding operation of the motion picture file is stopped and thereby, the generation of the actual data stream is stopped. Additionally, the temporary management file for temporarily storing the management information of the actual data stream is initialized. Specifically, the recording of the motion picture file is canceled by replacing the management information file stored in the optical recording medium with the temporary management file.

In embodiments of the present invention, the optical recording medium can be any suitable medium, such as a digital video disk RAM, and the recording of the motion picture file can be performed by any suitable file system format, such as a UDF file system.

### BRIEF DESCRIPTION OF THE DRAWINGS

The above aspects and other advantages of the present invention will be more apparent by describing an exemplary embodiment of the present invention with reference to the accompanying drawings, in which:

FIG. 1 is an exemplary view showing a menu list displaying names of the files having been recorded on a DVD and the name of the file being currently recorded;

FIG. 2 is a block diagram showing an exemplary optical recording/reproducing apparatus according to an embodiment of the present invention;

FIG. 3 is a diagram showing directories of an example optical recording medium capable of recording and/or reproducing general data according to an embodiment of the present invention; and

FIG. 4 is a flowchart showing an example data recording cancel method of the optical recording/reproducing apparatus of FIG. 2.

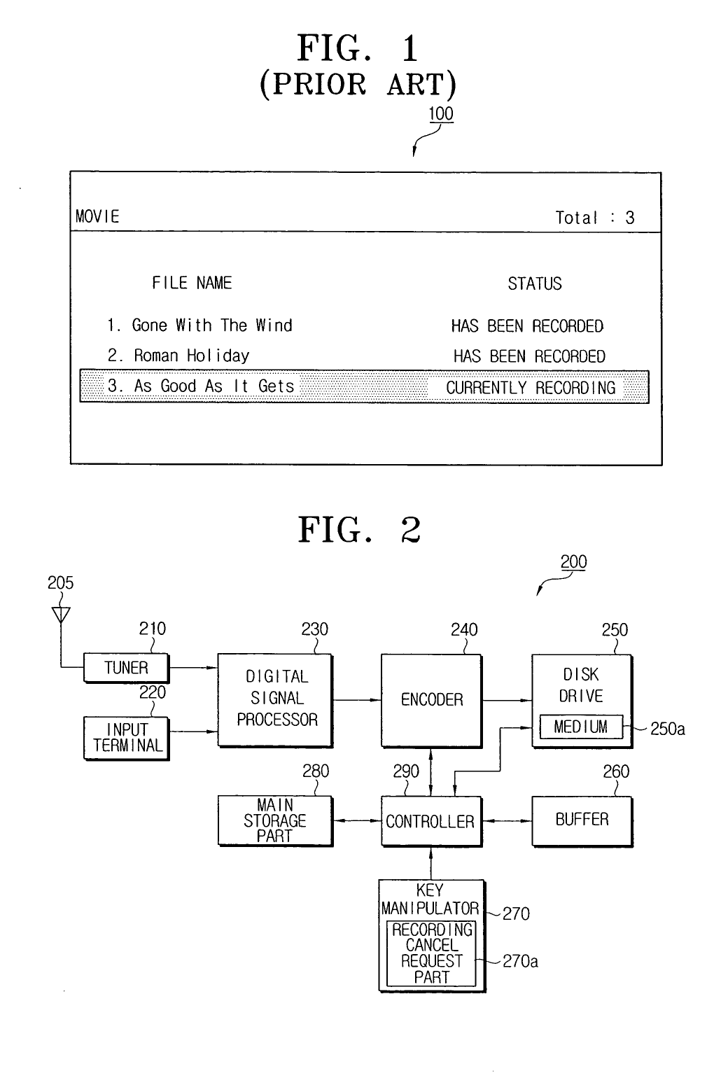

### DETAILED DESCRIPTION OF THE EXEMPLARY EMBODIMENTS

Hereinafter, embodiments of the present invention will be described in greater detail with reference to the accompanying drawings.

Referring to FIG. 2, an optical recording/reproducing apparatus 200, such as a DVDR, includes a tuner 210, an input terminal 220, a digital signal processor 230, an encoder 240, a disk drive 250, a buffer 260, a key manipulator 270, a main storage part 280, and a controller 290. Only the blocks of the optical recording/reproducing apparatus 200 related to the recording function are illustrated in FIG. 2. The other blocks of the optical recording/reproducing apparatus 200 are omitted in FIG. 2 for the convenience of the detailed description below.

The tuner 210 selects a predetermined channel from among a plurality of channels received through an antenna 205.

The input terminal 220 receives an AV signal provided from an image source, and outputs the received AV signal to an external device such as a television, through an output terminal (not shown). For example, the image source can be a cable broadcast source, a satellite broadcast source, a digital broadcast source, the internet, a camcorder or a set-top box. The external device can be a display device such as a television.

If the AV signal, input through the tuner 210 or the input terminal 220 is an analog signal, the digital signal processor 230 digitizes the received signal. If the AV signal is a digital signal, the digital signal processor 230 passes the AV signal through. Hereinafter, one such signal, specifically a motion picture file, is presented as an example of the digital AV signal in use with the embodiments described below.

In recording a digital AV signal, the encoder 240 encodes the digital AV signal with a suitable compression method to thereby generate an actual data stream. The encoder 240 is controlled by the controller 290, which is described in greater detail below, to generate and output the data stream in a predetermined recording unit. The predetermined recording unit is a basic unit of stored data, and can be a video object unit VOBU for configuring a video object (VOB). The VOBU can be comprised of at least one group of pictures (GOP).

Navigation data, indicating management information of the digital AV signal, is generated by the controller 290, and is also described in greater detail below.

The disk drive 250 records the data output from the encoder 240 on an optical recording medium 250a, or reads the data from the optical recording medium 250a. To achieve this function, the disk drive 250 includes an optical pickup (not shown). The optical pickup is well known to those skilled in the art, and therefore, the description thereof is omitted.

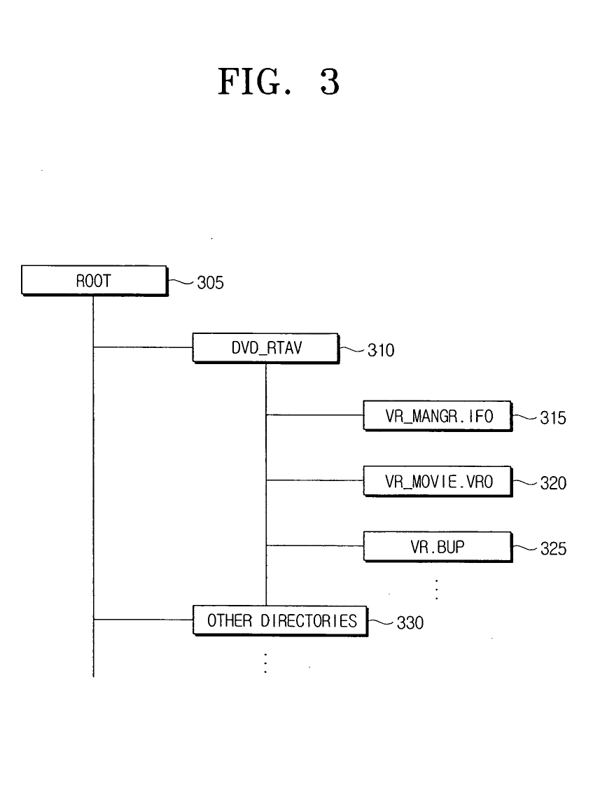

In the above embodiment, the optical recording medium 250a uses a DVD (Digital Versatile Disc), which is divided into DVD-R, DVD-RAM, and DVD±RW. The DVD-R allows recording once, while the DVD-RAM and DVD±RW allow recording multiple times. For example, in recording the data on the DVD-RAM, the DVD-RAM manages a plurality of data files by a UDF file system, and includes a logic directory structure as shown in FIG. 3. FIG. 3 is a block diagram showing the directories of an example optical recording medium 250a that is capable of recording and/or reproducing general data.

Referring to FIG. 3, a DVD_RTAV (DVD real-time AV) directory 310 is located under a root directory 305. One DVD_RTAV directory contains a management information file (*.IFO) 315 on which the navigation information is recorded, at least one data stream file (*.VRO) 320 in which the actual data stream is stored, and a backup file (*.BUP) 325 for the backup of the navigation information or the actual data stream.

For example, if the recording data is a motion picture file, the navigation information of the motion picture file is recorded on a ‘VR_MANGR.IFO’ file, and an AV stream of the actual data stream is recorded on a VR_MOVIE.VRO file. The navigation information is provided for the management of the AV stream and includes various information for the management of the recorded AV stream, such as a VOB search pointer of the VR_MOVIE.VRO file 320 (such as VRO information starting address), a recording time of the VOB, and a user's PGC information (program chain information). If the recording data is a still picture file, actual still image data is recorded on a ‘VR_STILL.VRO’ file (not shown), and if the recording data is an audio file, actual audio data is recorded on a ‘VR_AUDIO. VRO’ file (not shown). Hereafter, the motion picture file will be explained in greater detail as an example of the recording data in use with an embodiment of the present invention.

Returning to FIG. 2, the key manipulator 270 is provided as a user interface that outputs to the controller 290 a command to set or perform functions that are supported by the optical recording/reproducing apparatus 200. The key manipulator 270 comprises at least one manipulation key (not shown), such as a number key, a direction key, and an enter key. In the embodiment of FIG. 2, the key manipulator 270 is provided with a recording cancel request part 270a. The recording cancel request part 270a can output a request signal to cancel a recording process, such as when the optical recording/reproducing apparatus 200 is operated in a recording mode to record the AV signal on the optical recording medium 250a. The recording cancel request part 270a can be independently provided or added to another manipulation key (not shown).

The main storage part 280 stores a control program and an operating system to control and manage the entire operation of the optical recording/reproducing apparatus 200.

The controller 290 controls the overall operation of the optical recording/reproducing apparatus 200 based on the signal(s) generated from the key manipulator 270 and the control program stored in the main storage part 280.

When the recording mode is selected through the manipulation key part 270, the controller 290 controls the encoder 240 to encode the recording data received from the image source (not shown). Additionally, the controller 290 generates a temporary management file (VR_TEMP.IFO) in the buffer 260. These steps are performed, in part, because the optical recording medium 250a, such as the DVD-RAM, records the data under the controls of the UDF file system set in the operating system.

The temporary management file (VR_TEMP.IFO) is a copy of a management information file (VR_MANGR.IFO), which is stored in the optical recording medium 250a. In this embodiment, the management information file (VR_MANGR.IFO), which is copied as the temporary management file (VR_TEMP.IFO) during the generation of the temporary management file (VR_TEMP.IFO), can be defined as an initial management file (VR_FIRST.IFO). Accordingly, the initially generated temporary management file (VR_TEMP.IFO) (i.e. prior to upgrades) and the initial management file (VR_FIRST.IFO) have the same content. It is preferred that the temporary management file (VR_TEMP.IFO) and the initial management file (VR_FIRST.IFO) use the same file name, however, for purposes of clarification and explanation, the embodiment described herein uses different file names for the temporary management file (such as VR_TEMP.IFO) and the initial management file (such as VR_FIRST.IFO) for convenience.

When the controller 290 is notified that a VOBU is generated from the encoder 240, the controller 290 then generates management information corresponding to the VOBU, and upgrades the temporary management file (VR_TEMP.IFO) of the buffer 260. That is, every time an actual AV stream is generated by the encoder 240 in the VOBU part, the temporary management file (VR_TEMP.IFO) is upgraded with the management information corresponding to the generated AV stream.

When the recording of the AV stream is completed, that is, when all of the AV streams are generated and recorded on a data stream file (VR_MOVIE.VRO) of the optical recording medium 250a, the controller 290 copies the content of the final upgraded temporary management file (VR_TEMP.IFO) into the initial management file (VR_FIRST.IFO) of the optical recording medium 250a. Specifically, when the recording of the AV stream is completed, the controller 290 replaces the initial management information of the initial management file (VR_FIRST.IFO) with the final version of the management information stored in the temporary management file (VR_TEMP.IFO). Accordingly, the initial management file (VR_FIRST IFO) of the optical recording medium 250a is updated with the management information file (VR_MANGR.IFO). The controller 290 then manages the actual data stream file (VR_MOVIE.VRO) using the management information file (VR_MANGR.IFO). The controller 290 additionally generates a backup file (VR.BUP) in the optical recording medium 250a and updates a bit map table of the UDF file system. At this point, the recording process of the motion picture file is completed.

If the recording cancel request part 270a is selected before the completion of the recording process of the motion picture file, the controller 290 controls the encoder 240 to stop the encoding operation. If the generation of the AV stream is stopped, the controller 290 initializes the content of the temporary management file (VR_TEMP.IFO) temporarily stored in the buffer 260. More specifically, the controller 290 replaces the initial management information of the initial management file (VR_FIRST.IFO) with the management information of the temporary management file (VR_TEMP.IFO). That is, the controller 290 initializes the temporary management file (VR_TEMP.IFO) by copying the initial management file (VR_FIRST.IFO) into the temporary management file (VR_TEMP.IFO)

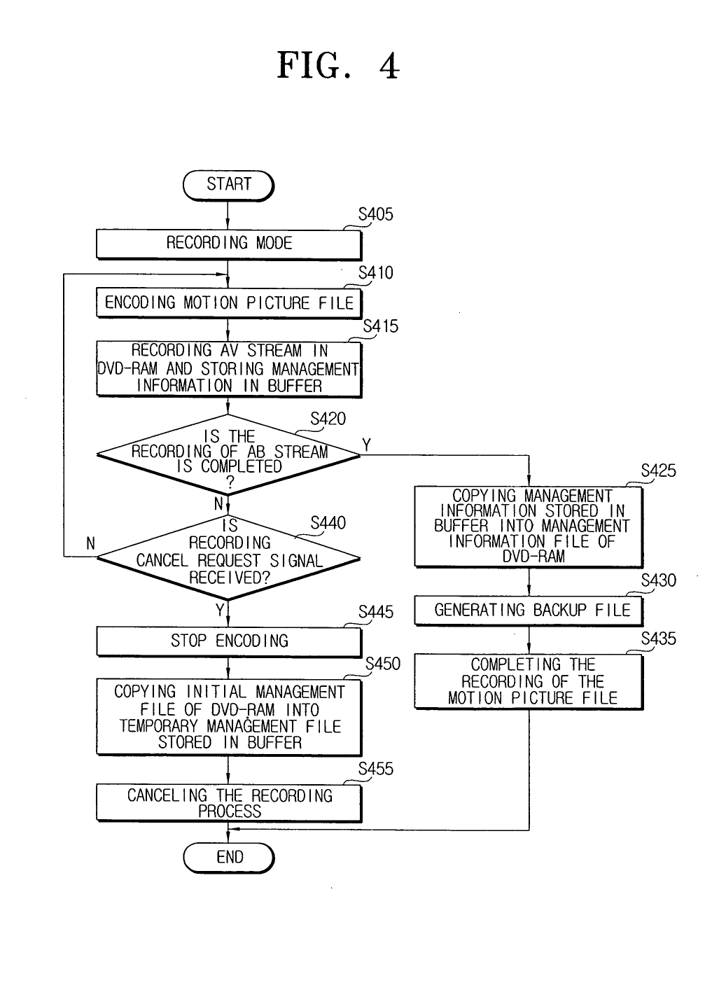

FIG. 4 is a flowchart showing a data recording cancel method of the optical recording/reproducing apparatus in accordance with an embodiment of the present invention.

Referring to FIGS. 2 through 4, when the optical recording/reproducing apparatus 200 is in a recording mode as noted in step (S405), the controller 290 generates a data stream file (VR_MOVIE.VRO) and an initial management file (VR_FIRST.IFO) in the optical recording medium 250a, and generates a temporary management file (VR_TEMP.IFO) in the buffer 260. At this point, the initial management file (VR_FIRST.IFO) and the temporary management file (VR_TEMP.IFO) have the same content.

The controller 290 controls the encoder 240 to encode recording data, such as a motion picture file, and generate an AV stream at step (S410). Each time the AV stream of the VOBU is generated by the encoder 240 at step (S410), the controller 290 generates management information corresponding to the generated VOBU and stores the management information in the temporary management file (VR_TEMP.IFO) at step (S415). Accordingly, in step (S415) the temporary management file (VR_TEMP.IFO) is upgraded.

After step (S415), the controller 290 confirms whether the recording of the AV stream is completed at step (S420), and if so, the controller 290 copies the final version of the management information stored in the temporary management file (VR_TEMP.IFO) of the buffer 260 into the initial management file (VR_FIRST.IFO) at step (S425). In doing so, the actual AV stream is recorded on the data stream file (VR_MOVIE.VRO), while the management information for the management of the AV stream is stored in the temporary management file (VR_TEMP.IFO) of the buffer 260.

After step (S425), the controller 290 then controls the optical recording medium 250a to generate a backup file (VR.BUP) of the management information file (VR_MANGR.IFO) at step (S430). Accordingly, at step (S435), the content of the initial management file (VR_FIRST.IFO) is then upgraded to perform the function of the actual management information file (VR_MANGR.IFO), the final stored management information file is named ‘VR_MANGR.IFO’, and the recording process of the motion picture file is completed.

When the ongoing recording process is confirmed at step (S420) and a recording cancel request signal is received from the recording cancel request part 270a at step (S440), the controller 290 controls the encoder 240 to stop the encoding operation at step (S445).

If the encoding operation is stopped at step (S445), the controller 290 copies the initial management file (VR_FIRST.IFO) generated at step (S405), i.e., a management information file (VR_MANGR.IFO) before the recording command, into the temporary management file (VR_TEMP.IFO) stored in the buffer 260 at step (S450). Accordingly, the temporary management file (VR_TEMP.IFO) stored in the buffer 260 is initialized, and there is no change in the content of the UDF file system. That is, the previously-recorded data is canceled, and the bit map table of the UDF file system is not upgraded such that the state existing before the recording process is maintained at step (S455).

When the ongoing recording process is confirmed at step (S420) and a recording cancel request signal is not received from the recording cancel request part 270a at step (S440), the controller repeats the steps (S410) to (S440) until the recording cancel request signal is received from the recording cancel request part 270a or until the recording process is completed.

The optical recording/reproducing apparatus 200 and the data recording cancel method thereof can further include a mode selection part (not shown) for selecting modes of the above-described function according to yet another embodiment of the present invention. The optical recording/reproducing apparatus 200 can be designed in a manner wherein the operations related to the recording cancel request part 270a are performed only if the cancel operation is pre-set by the mode selection part (not shown). Accordingly, even if the recording cancel request part 270a is mistakenly selected by a user, the above-mentioned operation is not performed.

Additionally, in yet another embodiment of the present invention, the optical recording/reproducing apparatus 200 and the data recording cancel method thereof can be designed to control an OSD processor (not shown). When the recording cancel request part 270a is selected, the controller 290 controls the OSD processor to display a message, such as “Do you want to delete the data being processed?”. Therefore, even when the recording cancel request part 270a is mistakenly selected by the user, the data being currently processed can be prevented from being deleted.

In yet another embodiment of the present invention, the encoder 240 of the optical recording/reproducing apparatus 200 can be provided to compress the digital AV signal using the MPEG (Motion Pictures Experts Group)-2 method, although this is not limiting and any suitable method can be provided.

In the above examples, the optical recording/reproducing apparatus 200 and the data recording cancel method thereof are described in the case where the data is recorded on the DVD employing the UDF file system. However, the embodiments of the present invention can be used in a variety of applications, such as the case where the data is recorded on a HDD.

As described above, the optical recording/reproducing apparatus 200 and the data recording cancel method thereof are capable of canceling the recording process of the data with one simple key manipulation while in the process of recording the data. That is, when the recording cancel request signal is received from an input device, such as a remote controller, the management information file which is temporarily stored while the data is recorded in the VOBU, is initialized such that the data recording process is canceled. Also, since there is no further need to manipulate the key, difficult and/or confusing steps to cancel the data recording process can be omitted.

The foregoing embodiments and advantages are merely exemplary and are not to be construed as limiting the present invention. The description of the embodiments of the present invention is intended to be illustrative, and not to limit the scope of the claims. Many alternatives, modifications and variations will be apparent to those skilled in the art, the scope of which is defined in the following claims and their equivalents.

1. An optical recording/reproducing apparatus comprising:
an encoder for encoding a recording data signal and generating a data stream;
a buffer for storing a temporary management file including management information for the management of a data stream file while the data stream is being recorded on the data stream file of an optical recording medium;
a controller generating and storing the management information in the temporary management file, and when receiving a recording cancel request signal while in the process of recording the data stream on the data stream file of the optical recording medium, the controller further stopping the encoding operation of the encoder and initializing the temporary management file stored in the buffer.

2. The optical recording/reproducing apparatus of claim 1, wherein:
the controller controls the encoder to generate the data stream in a predetermined recording unit by a predetermined file system; and
the controller further controls the encoder to generate the management information corresponding to the data stream of the predetermined recording unit and store the management information in the temporary management file.

3. The optical recording/reproducing apparatus of claim 2, wherein:
the controller divides the recording data into the data stream file and an initial management file for the management of the data stream file and records the recording data on the optical recording medium; and
the controller stops the encoding when receiving the recording cancel request signal while the controller is in the process of recording the data stream and initializes the temporary management file.

4. The optical recording/reproducing apparatus of claim 3, wherein:
the controller initializes the temporary management file by replacing the management information included in the temporary management file stored in the buffer with an initial management information of the initial management file.

5. The optical recording/reproducing apparatus of claim 3, wherein:
the controller replaces the initial management information of the initial management file with a final version of management information stored in the temporary management file when the recording process of the data stream is completed.

6. The optical recording/reproducing apparatus of claim 5, wherein:
the optical recording medium comprises a DVD (Digital Versatile Disc) RAM; and
the predetermined file system comprises a UDF (Universal Disk Format) file system.

7. A data recording cancel method of an optical recording/reproducing apparatus, comprising the steps of:
encoding a recording data signal and generating a data stream;
recording the data stream on a data stream file of an optical recording medium;
generating management information for the management of the data stream file;
temporarily storing the management information in a temporary management file; and
stopping the encoding in response to a recording cancel request signal and initializing the temporary management file.

8. The data recording cancel method of claim 7, wherein:
the encoding step comprises the step of:
generating the data stream in a predetermined recording unit by a predetermined file system; and
the management information generating step comprises the step of:
generating the management information corresponding to the data stream of the predetermined recording unit.

9. The data recording cancel method of claim 8, wherein:
the recording data is divided into the data stream file and an initial management file for the management of the data stream file and wherein the recording data is recorded on the optical recording medium; and
the initializing step initializes the temporary management file by replacing the management information stored in the temporary management file with an initial management information of the initial management file.

10. The data recording cancel method of claim 9, wherein:
the optical recording medium comprises a DVD (Digital Versatile Disc) RAM; and
the predetermined file system comprises a UDF (Universal Disk Format) file system.
